(19) United States
(12) Patent Application Publication
(10) Pub. No.: US 2026/0326553 A1
(43) Pub. Date: Oct. 22, 2026

(54) RECONFIGURABLE DISPLAY ASSEMBLY

(71) Applicant: GM Global Technology Operations LLC, Detroit, MI (US)

(72) Inventors: Joseph F. Szczerba, Grand Blanc, MI (US); Ki Hyun Ahn, Lake Orion, MI (US); Roy J. Mathieu, Rochester Hills, MI (US)

(21) Appl. No.: 19/185,537

(22) Filed: Apr. 22, 2025

(51) Int. Cl. B60K 35/22; B60K 35/53; B60K 35/60

(52) U.S. Cl. CPC B60K 35/22; B60K 35/53; B60K 35/60; B60K 2360/822

(57) ABSTRACT

An assembly for a vehicle includes a dashboard and a reconfigurable display assembly including a first display and a second display that are movably mounted on the dashboard. The reconfigurable display assembly is adjustable between a first configuration in which the first display and the second display are spaced apart and a second configuration in which the first display is directly adjacent to the second display.

### INTRODUCTION

The subject disclosure relates to vehicles and, in particular, to a reconfigurable display assembly for vehicles.

Vehicles may include various displays, including instrument panel displays and infotainment system displays. Improvements to displays is desirable.

### SUMMARY

In one exemplary embodiment, an assembly for a vehicle comprises a dashboard and a reconfigurable display assembly comprising a first display and a second display that are movably mounted on the dashboard. The reconfigurable display assembly is adjustable between a first configuration in which the first display and the second display are spaced apart and a second configuration in which the first display is directly adjacent to the second display.

In addition to one or more of the features described herein, the first display and the second display are in direct contact in the second configuration.

In addition to one or more of the features described herein, the reconfigurable display assembly further comprises a third display movably mounted on the dashboard, the third display being spaced from the first display and the second display in the first configuration and directly adjacent to the first display and the second display in the second configuration.

In addition to one or more of the features described herein, the assembly further comprises a display adjustment assembly configured to rotate the first display from the first configuration to the second configuration.

In addition to one or more of the features described herein, the assembly further comprises a display adjustment assembly configured to translate the second display from the first configuration to the second configuration.

In addition to one or more of the features described herein, the first display comprises a side display surface and a main display surface that are configured to display images and/or video, and the second display comprises a main display surface configured to display images and/or video.

In addition to one or more of the features described herein, the main display surface of the first display and the main display surface of the second display are positioned to be continuous with each other in the second configuration.

In addition to one or more of the features described herein, the main display surface of the first display and the main display surface of the second display are parallel to each other in the second configuration.

In another exemplary embodiment, a vehicle comprises a dashboard; and a reconfigurable display assembly comprising a first display and a second display that are movably mounted on the dashboard. The reconfigurable display assembly is adjustable between a first configuration in which the first display and the second display are spaced apart and a second configuration in which the first display is directly adjacent to the second display.

In addition to one or more of the features described herein, the first display and the second display are in direct contact in the second configuration.

In addition to one or more of the features described herein, the first display is an instrument panel display and the second display is an infotainment system display.

In addition to one or more of the features described herein, the reconfigurable display assembly further comprises a third display movably mounted on the dashboard, the third display being spaced from the first display and the second display in the first configuration and directly adjacent to the first display and the second display in the second configuration.

In addition to one or more of the features described herein, the vehicle further comprises a display adjustment assembly configured to rotate the first display from the first configuration to the second configuration.

In addition to one or more of the features described herein, the vehicle further comprises a display adjustment assembly configured to translate the second display from the first configuration to the second configuration.

In addition to one or more of the features described herein, the first display comprises a side display surface and a main display surface that are configured to display images and/or video, and the second display comprises a main display surface configured to display images and/or video.

In addition to one or more of the features described herein, the main display surface of the first display and the main display surface of the second display are positioned to be continuous with each other in the second configuration.

In addition to one or more of the features described herein, in the first configuration, the side display surface faces a rearward direction of the vehicle, and in the second configuration, the main display surface faces the rearward direction of the vehicle.

In addition to one or more of the features described herein, the vehicle further comprises a controller configured to adjust the reconfigurable display assembly based on receiving a selection of a new vehicle application, determination of a change in driving context, or receiving selection of a reconfiguration option.

In addition to one or more of the features described herein, the main display surface of the first display and the main display surface of the second display are parallel to each other in the second configuration.

In yet another exemplary embodiment, a vehicle comprises a dashboard, a reconfigurable display assembly comprising a first display and a second display that are movably mounted on the dashboard, a display adjustment assembly, one or more display adjustment assemblies, and a controller. The reconfigurable display assembly is adjustable between a first configuration in which the first display and the second display are spaced apart and a second configuration in which the first display directly contacts the second display. The one or more display adjustment assemblies is configured to rotate the first display from the first configuration to the second configuration and to translate the second display from the first configuration to the second configuration. The first display comprises a side display surface and a main display surface that are configured to display images and/or video, and the second display comprises a main display surface configured to display images and/or video. The main display surface of the first display and the main display surface of the second display are positioned to be continuous with each other in the second configuration. In the first configuration, the side display surface faces a rearward direction of the vehicle, and in the second configuration, the main display surface faces the rearward direction of the vehicle. The main display surface of the first display and the main display surface of the second display are parallel to each other in the second configuration.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a side view of a vehicle including a reconfigurable display assembly according to a non-limiting example;

FIG. 2A shows a first configuration of a reconfigurable display assembly according to one or more embodiments;

FIG. 2B shows a second configuration of the reconfigurable display assembly of FIG. 2A;

FIG. 2C shows a third configuration of the reconfigurable display assembly of FIG. 2A;

FIG. 2D shows a fourth configuration of the reconfigurable display assembly of FIG. 2A;

FIG. 3A shows a first configuration of a reconfigurable display assembly according to one or more embodiments;

FIG. 3B shows a second configuration of the reconfigurable display assembly of FIG. 3A;

FIG. 3C shows a second configuration of the reconfigurable display assembly of FIG. 3A;

FIG. 4A shows a first configuration of a reconfigurable display assembly according to one or more embodiments;

FIG. 4B shows a second configuration of the reconfigurable display assembly of FIG. 4A;

FIG. 4C shows a third configuration of the reconfigurable display assembly of FIG. 4A;

FIG. 4D shows a second configuration of the reconfigurable display assembly of FIG. 4A;

FIG. 5A shows a first configuration of a reconfigurable display assembly according to one or more embodiments;

FIG. 5B shows a second configuration of the reconfigurable display assembly of FIG. 5A;

FIG. 6A shows a display adjustment assembly in a first rotational position according to one or more embodiments;

FIG. 6B shows the display adjustment assembly of FIG. 6A in a second rotational position;

FIG. 7 shows a display adjustment assembly according to one or more embodiments;

FIG. 8 shows a display adjustment assembly according to one or more embodiments;

FIG. 9 shows a display adjustment assembly according to one or more embodiments;

FIG. 10 shows a display adjustment assembly according to one or more embodiments;

FIG. 11 is a schematic diagram showing a system for controlling a reconfigurable display assembly according to one or more embodiments; and

FIG. 12 is a flowchart showing a process of controlling a reconfigurable display assembly according to one or more embodiments.

### DETAILED DESCRIPTION

The following description is merely exemplary in nature and is not intended to limit the present disclosure, its application or uses.

It should be understood that throughout the drawings, corresponding reference numerals indicate like or corresponding parts and features. As used herein, the term controller refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

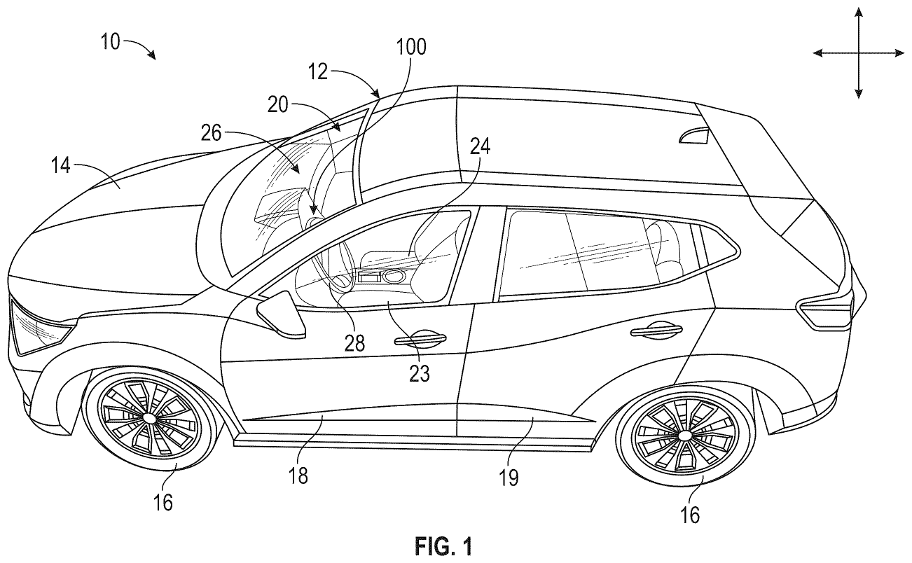

FIG. 1 shows a vehicle 10 according to a non-limiting example. The vehicle 10 defines an upward direction U, a downward direction D, a forward direction F, and a rearward direction R. The vehicle 10 includes a vehicle body 12 supported on a plurality of wheels 16. One or more of the plurality of wheels 16 is steerable via a steering wheel 28. The vehicle body 12 defines, in part, a passenger compartment 20 having a driver seat 23 and a passenger seat 24 positioned behind a dashboard 26. The vehicle body 12 further includes front and rear doors 18, 19. The vehicle body 12 further defines, in part, a prime mover compartment 14 that houses a prime mover. The prime mover may be, for example, an engine, a motor, or both an engine and a motor in a hybrid configuration. The vehicle 10 may include a reconfigurable display assembly 100 within the passenger compartment 20 according to one or more embodiments.

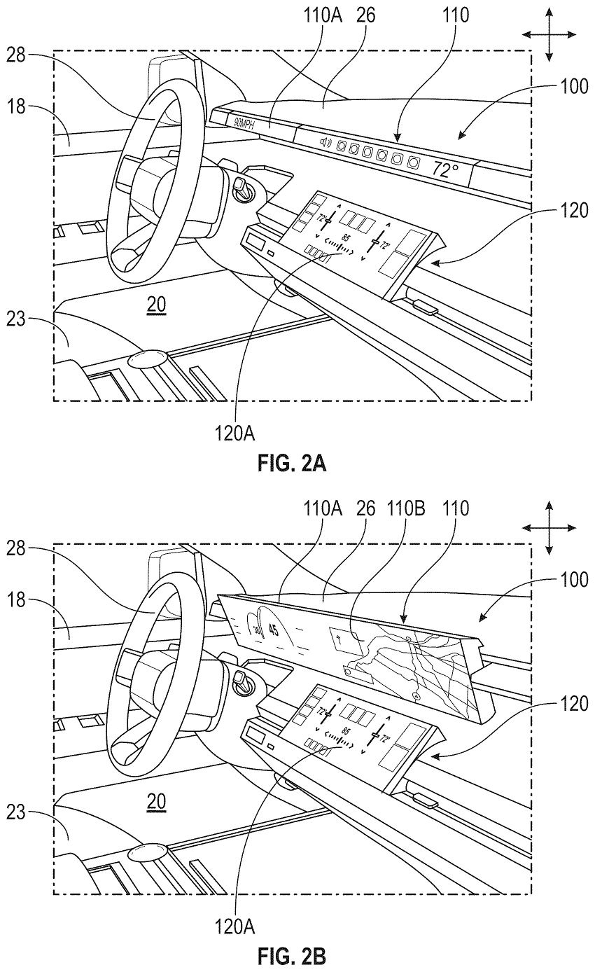

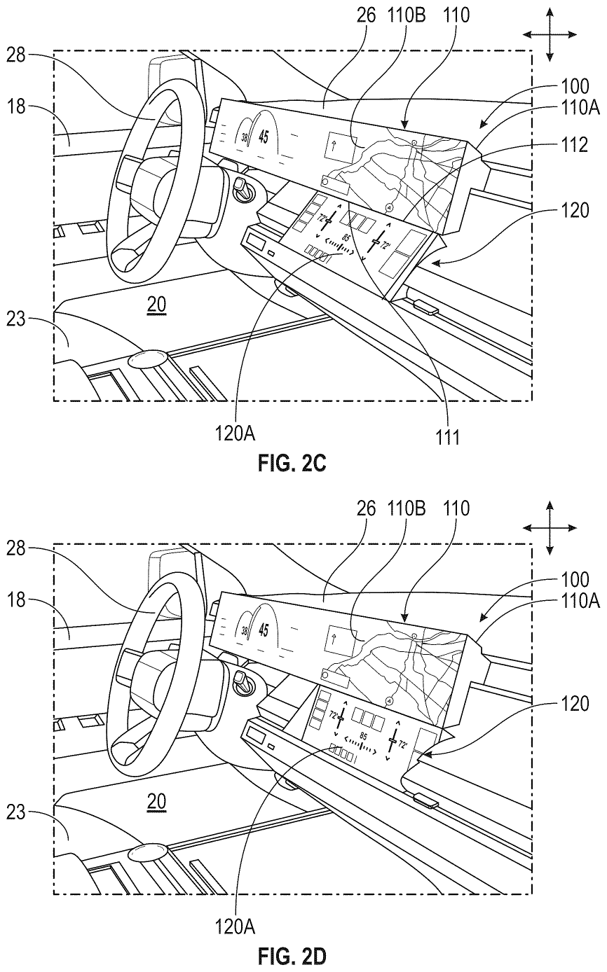

FIGS. 2A-2D respectively show first, second, third, and fourth configurations of a reconfigurable display assembly 100 according to one or more embodiments. The reconfigurable display assembly 100 may include an instrument panel display 110 and an infotainment system display 120. The instrument panel display 110 is part of an instrument panel system and may provide information in visual and/or audio form about the vehicle and/or the road. The instrument panel display 110 may provide the visual component of the instrument panel system and may include light source(s) and may be, for example, a liquid crystal display. An infotainment system display 120 may be part of an infotainment system that may provide audio and/or visual entertainment as well as provide information in audio and/or visual form about the vehicle and/or the road. As a non-limiting example, the infotainment system display 120 may provide the visual component of the infotainment system, and may include light source(s) and may be, for example, a liquid crystal display. The instrument panel display 110 and/or the infotainment system display 120 may be mounted on the dashboard 26.

The instrument panel display 110 may include a side display surface 110A and a main display surface 110B, and the infotainment system display 120 may include a main display surface 120A. The side display surface, 110A, the main display surface 110B, and the main display surface 120A are configured to display images and/or video.

In the first configuration shown in FIG. 2A, the side display surface 110A may face a rearward direction R of the vehicle 10 so as to be visible to a driver, while the main display surface 110B may be stowed within the dashboard 26 so as to not be visible to the driver. In the first configuration, the main display surface 110B may be OFF, while the side display surface 110A may be ON.

The reconfigurable display assembly 100 may adjust the instrument panel display 110 from the first configuration shown in FIG. 2A to the second configuration shown in FIG. 2B, which may be an intermediate configuration, then to the third configuration shown in FIG. 2C. The instrument panel display 110 may be adjusted by, for example, rotation. Alternatively, the instrument panel display 110 may be adjusted by translation or a combination of translation and rotation. In the third configuration, the main display surface 110B may face the rearward direction R of the vehicle 10 so as to be visible to the driver, while the side display surface 110A may face an upward direction U, a forward direction F, or a combination thereof of the vehicle 10 so as to not be visible to the driver. According to one or more embodiments, the side display surface 110A may be OFF in the third configuration while the main display surface 110B may be ON. As shown in FIG. 2C, in the third configuration, a lower end 111 of the main display surface 110B of the instrument panel display 110 and an upper end 112 of the main display surface 120A of the infotainment system display 120 may be positioned directly adjacent to each other. According to one or more embodiments, in the third configuration, the instrument panel display 110 may be in direct contact with the infotainment system display 120. According to one or more embodiments, the lower end 111 of the main display surface 110B of the instrument panel display 110 and the upper end 112 of the main display surface 120A of the infotainment system display 120 may form a continuous display. However, in the third configuration shown in FIG. 2C, the main display surface 110B of the instrument panel display 110 and the main display surface 120A of the infotainment system display 120 may face different directions.

The infotainment system display 120 may be adjusted to a fourth configuration shown in FIG. 2D in which the main display surface 110B of the instrument panel display 110 and the main display surface 120A of the infotainment system display 120 are parallel to each other. The infotainment system display 120 may be adjusted by, for example, rotation. Alternatively, the infotainment system display 120 may be adjusted by translation or a combination of translation and rotation. According to one or more embodiments, in the fourth configuration of the reconfigurable display assembly 100, the main display surface 110B of the instrument panel display 110 and the main display surface 120A of the infotainment system display 120 may form a small angle with each other of within 5 degrees, within 4 degrees, within 3 degrees, within 2 degrees, or within 1 degree.

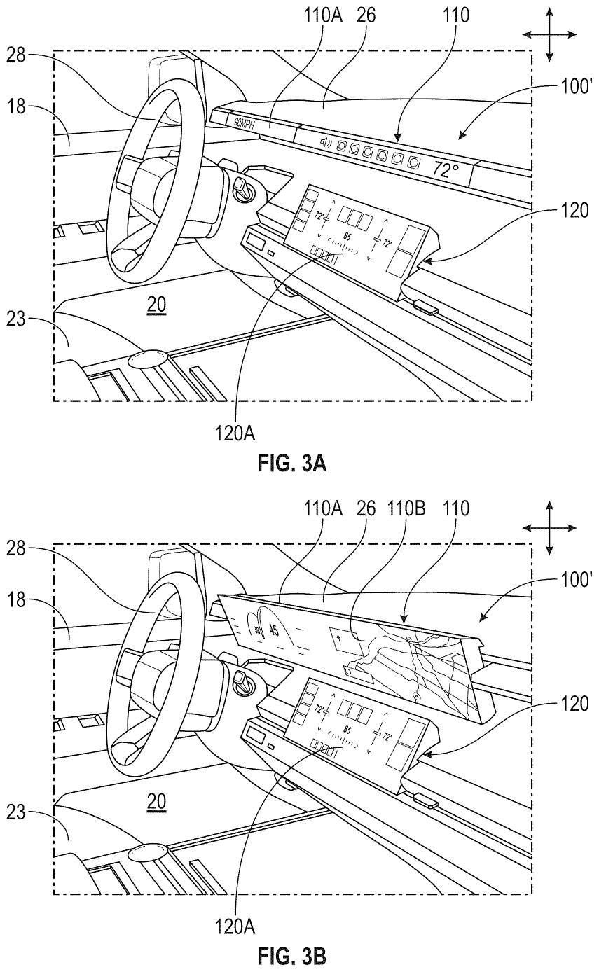

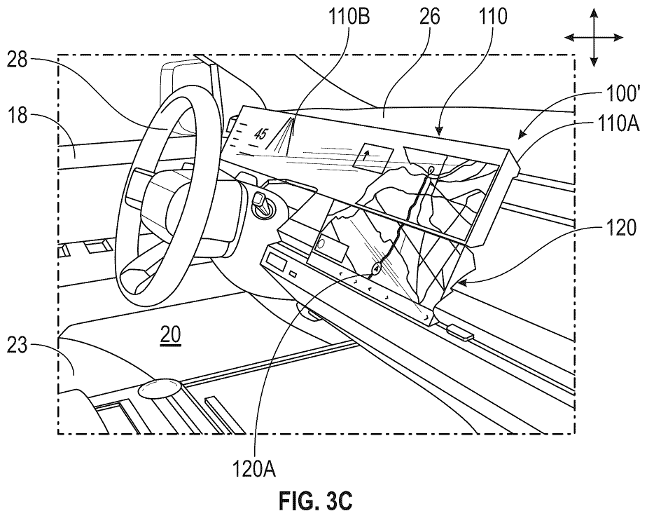

FIGS. 3A-3C respectively show first, second, and third configurations of a reconfigurable display assembly 100′ according to one or more embodiments. The reconfigurable display assembly 100′ shown in FIGS. 3A-3C is similar to the reconfigurable display assembly 100 shown in FIGS. 2A-2D, but the instrument panel display 110 may be adjusted directly to the third configuration shown in FIG. 3C in which the main display surface 110B of the instrument panel display 110 and the main display surface 120A of the infotainment system display 120 are parallel to each other, or form a small angle with each other of within 5 degrees, within 4 degrees, within 3 degrees, within 2 degrees, or within 1 degree, without adjustment of the infotainment system display 120.

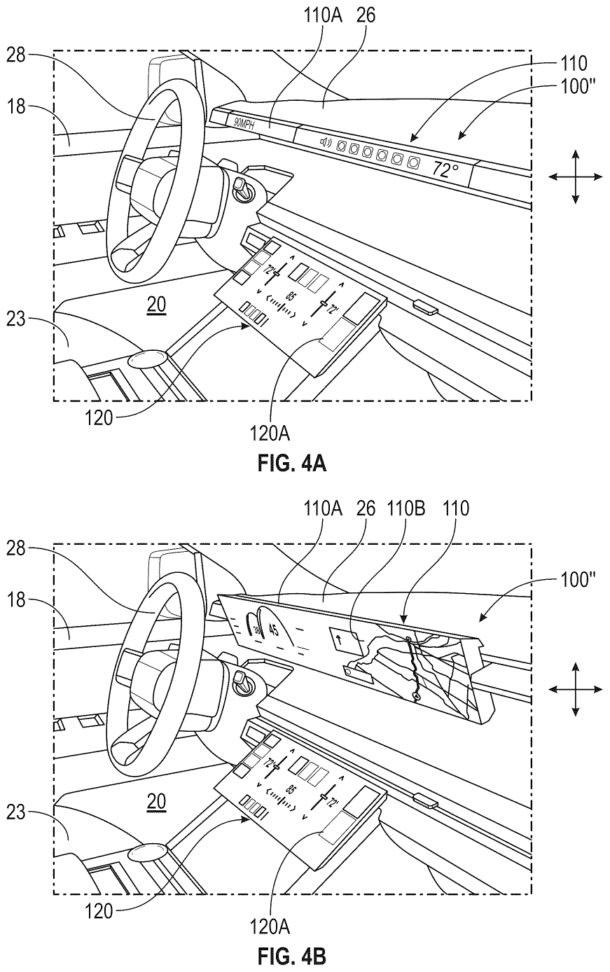

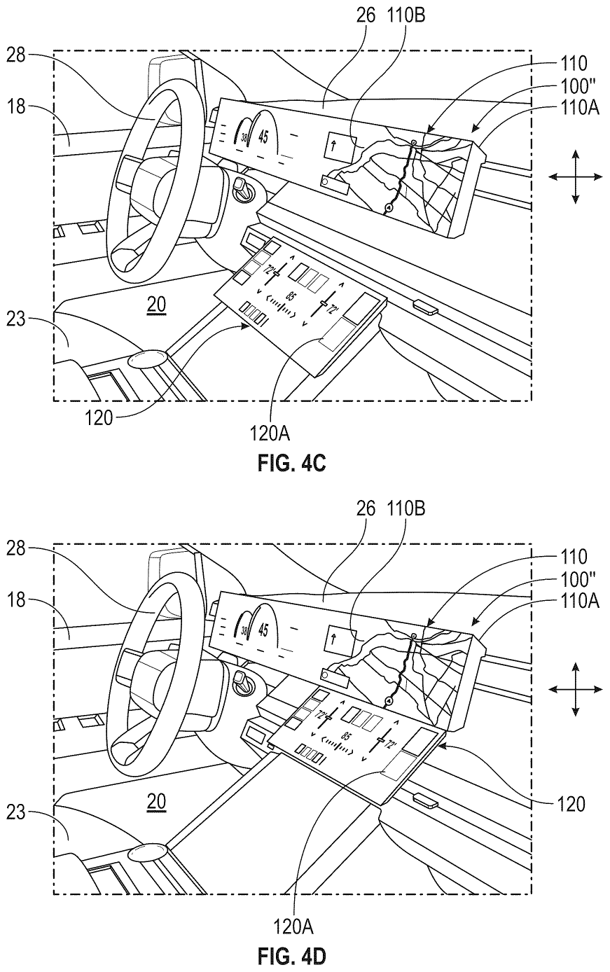

FIGS. 4A-4D respectively show first, second, third, and fourth configurations of a reconfigurable display assembly 100″ according to one or more embodiments. In the reconfigurable display assembly 100″, the instrument panel display 110 may be adjusted similarly to the reconfigurable display assembly 100 shown in FIGS. 2A-2D. However, in the third configuration shown in FIG. 4C, the instrument panel display 110 and the infotainment system display 120 are spaced apart from each other. The reconfigurable display assembly 100″ may be adjusted from the third configuration shown in FIG. 4C to the fourth configuration shown in FIG. 4D by adjusting the infotainment system display 120 to a position directly adjacent to the instrument panel display 110. According to one or more embodiments, in the fourth configuration, the instrument panel display 110 may be in direct contact with the infotainment system display 120. The infotainment system display 120 may be adjusted by, for example, translation. Alternatively, the infotainment system display 120 may be adjusted by rotation or a combination of translation and rotation. According to one or more embodiments, in the fourth configuration, the main display surface 120A of the infotainment system display 120 is continuous with the main display surface 110B of the instrument panel display 110.

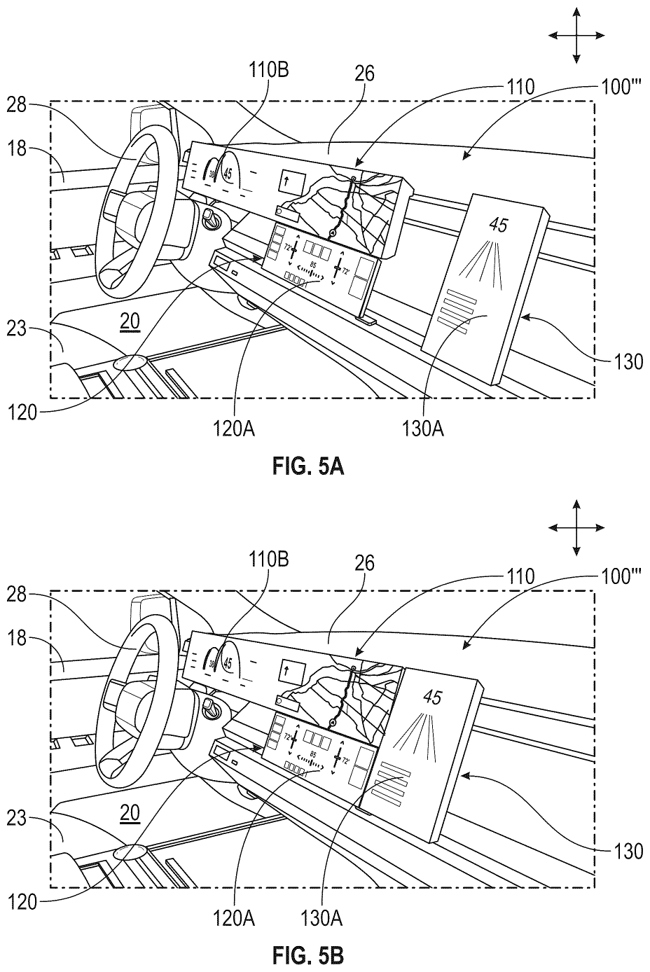

FIGS. 5A and 5B respectively show first and second configurations of a reconfigurable display assembly 100′″ according to one or more embodiments. In the first configuration of the reconfigurable display assembly 100′″ shown in FIG. 5A, the instrument panel display 110 and the infotainment system display 120 are in a configuration similar to that shown in FIGS. 2D and 3C. In a non-limiting example, the reconfigurable display assembly 100′″ may be adjusted similarly to the process shown in in FIGS. 2A-2D to reach the first configuration shown in FIG. 5A. The reconfigurable display assembly 100′″ further includes a passenger display 130. The passenger display 130 includes a main display surface 130A. The main display surface 130A is configured to display images and/or video. The passenger display 130 may be part of an infotainment system that may provide audio and/or visual entertainment as well as provide information in audio and/or visual form about the vehicle and/or the road. As a non-limiting example, the passenger display 130 may provide the visual component of the infotainment system, and may include light source(s) and may be, for example, a liquid crystal display. The passenger display 130 may be a personal display device, e.g., a tablet.

In the first configuration of the reconfigurable display assembly 100′″ shown in FIG. 5A, the passenger display 130 is spaced apart from the instrument panel display 110 and/or the infotainment system display 120. The reconfigurable display assembly 100′″ may adjust the passenger display 130 from the first configuration shown in FIG. 5A to the second configuration shown in FIG. 5B in which the passenger display 130 is directly adjacent to the instrument panel display 110 and/or the infotainment system display 120. In a non-limiting example, in the second configuration of the reconfigurable display assembly 100′″, the passenger display 130 may come in direct contact with the instrument panel display 110 and/or the infotainment system display 120. The passenger display 130 may be adjusted by, for example, translation. Alternatively, the passenger display 130 may be adjusted by rotation or a combination of translation and rotation. According to one or more embodiments, in the second configuration, the main display surface 130A of the passenger display 130 is continuous with the main display surface 110B of the instrument panel display 110.

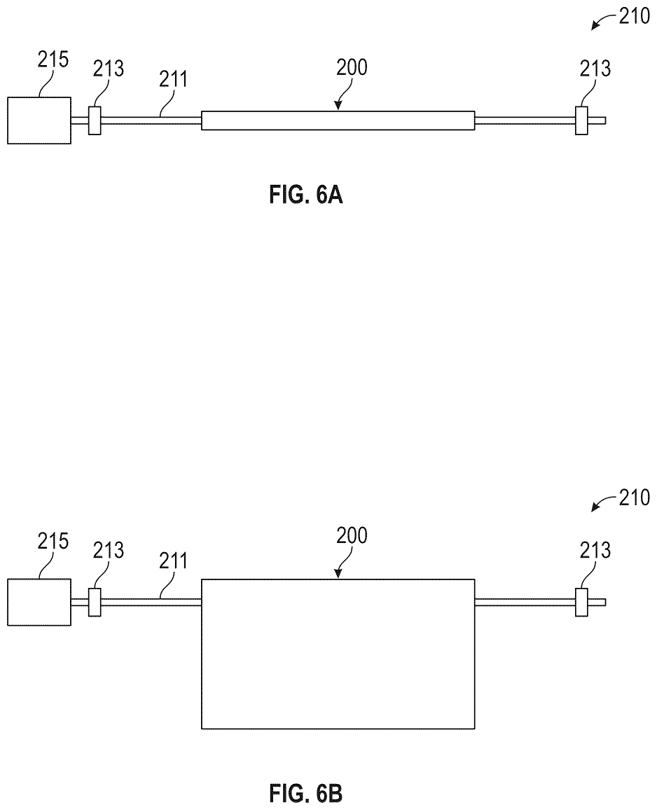

According to non-limiting examples, adjustment of the instrument panel display 110, the infotainment system display 120, and/or the passenger display 130 may be performed by display adjustment assemblies 210, 220, 230, 240, 250 shown in FIGS. 6A-10.

FIGS. 6A and 6B show a display adjustment assembly 210 according to one or more embodiments. The display adjustment assembly 210 includes a display 200. The display 200 may be the instrument panel display 110, the infotainment system display 120, or the passenger display 130. The display adjustment assembly 210 includes a rotation shaft 211, a pair of shaft mounts 213 on which the rotation shaft 211 is mounted, and a motor 215 coupled to the rotation shaft 211 and configured to rotate the rotation shaft 211. The rotation shaft 211 may be fixed to the display 200 such that, when the motor 215 rotates the rotation shaft 211, the display 200 is rotated with the rotation shaft 211 as a rotation axis. As a non-limiting example, the display 200 may be rotated from a first rotational position shown in FIG. 6A to a second rotational position shown in FIG. 6B.

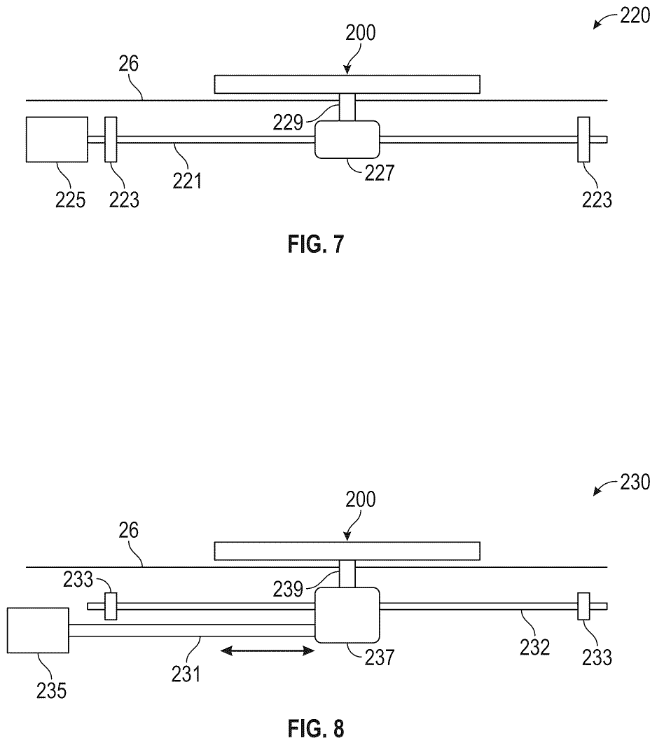

FIG. 7 shows a display adjustment assembly 220 according to one or more embodiments. The display adjustment assembly 220 includes a display 200. The display 200 may be the instrument panel display 110, the infotainment system display 120, or the passenger display 130. The display adjustment assembly 220 includes a rotation shaft 221, a pair of shaft mounts 223 on which the rotation shaft 221 is mounted, and a motor 225 coupled to the rotation shaft 221 and configured to rotate the rotation shaft 221. The display 200 may be fixed to a lead screw 227 via a display mount 229. The display mount 229 may be disposed within a lateral slit (not shown) in the dashboard 26. When the motor 225 rotates the rotation shaft 221, the lead screw 227 moves along an axial direction of the rotation shaft 221, resulting in translational movement of the display 200 parallel to the axial direction of the rotation shaft 221.

FIG. 8 shows a display adjustment assembly 230 according to one or more embodiments. The display adjustment assembly 230 includes a display 200. The display 200 may be the instrument panel display 110, the infotainment system display 120, or the passenger display 130. The display adjustment assembly 230 includes a rod 231, one or more guide rails 232, a pair of guide mounts 233 on which the one or more guide rails 232 is mounted, and a linear motor 235 coupled to the rod 231 and configured to move the rod 231 linearly along an axial direction of the rod 231. The display 200 may be fixed to a carriage 237 via a display mount 239. The display mount 239 may be disposed within a lateral slit (not shown) in the dashboard 26. When the linear motor 235 linearly moves the rod 231, the carriage 237 is moved by the rod 231 along the axial direction of the rod 231, resulting in translational movement of the display 200 on the one or more guide rails 232 parallel to the axial direction of the rod 231.

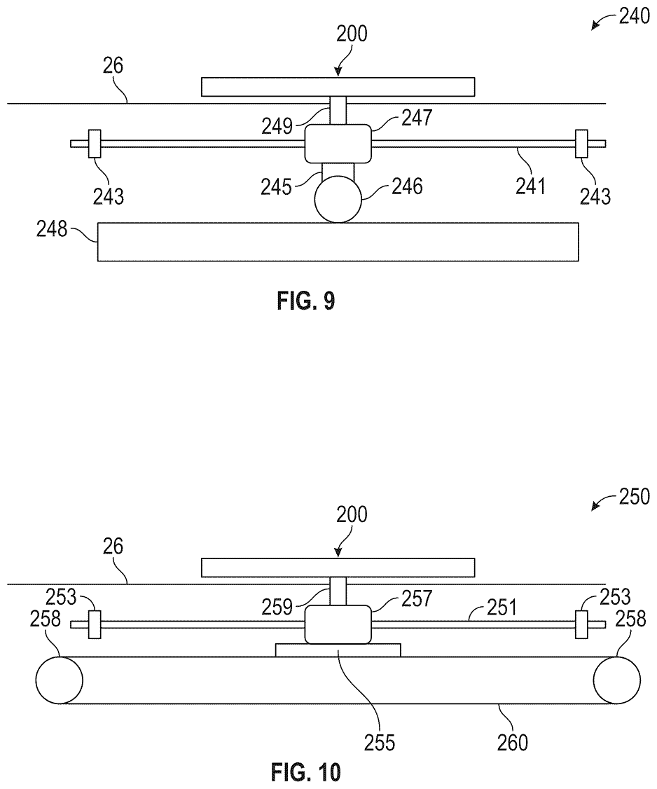

FIG. 9 shows a display adjustment assembly 240 according to one or more embodiments. The display adjustment assembly 240 includes a display 200. The display 200 may be the instrument panel display 110, the infotainment system display 120, or the passenger display 130. The display adjustment assembly 240 includes one or more guide rails 241, a pair of guide mounts 243 on which the one or more guide rails 241 is mounted, a pinion gear 246, a motor 245 coupled to the pinion gear 246 and configured to rotate the pinion gear 246, and a rack gear 248 on which the pinion gear 246 is mounted. Gear teeth of the pinion gear 246 are in mating engagement with gear teeth of the rack gear 248. The display 200 may be fixed to a carriage 247 via a display mount 249. The display mount 249 may be disposed within a lateral slit (not shown) in the dashboard 26. When the motor 245 rotates the pinion gear 246, the pinion gear 246 moves on the rack gear 248, resulting in translational movement of the display 200 on the one or more guide rails 241.

FIG. 10 shows a display adjustment assembly 250 according to one or more embodiments. The display adjustment assembly 250 includes a display 200. The display 200 may be the instrument panel display 110, the infotainment system display 120, or the passenger display 130. The display adjustment assembly 250 includes one or more guide rails 251, a pair of guide mounts 253 on which the one or more guide rails 251 is mounted, a carriage 257 on which the display 200 is mounted via a display mount 259, a carriage mount 255 on which the carriage 257 is mounted, and a pair of rollers 258 with a belt 260 disposed thereon. The carriage mount 255 may be fixed to the belt 260. The display mount 259 may be disposed within a lateral slit (not shown) in the dashboard 26. When one or more of the rollers 258 is rotated via, e.g., a motor (not shown), the movement of the belt 260 results in translational movement of the display 200 on the one or more guide rails 251.

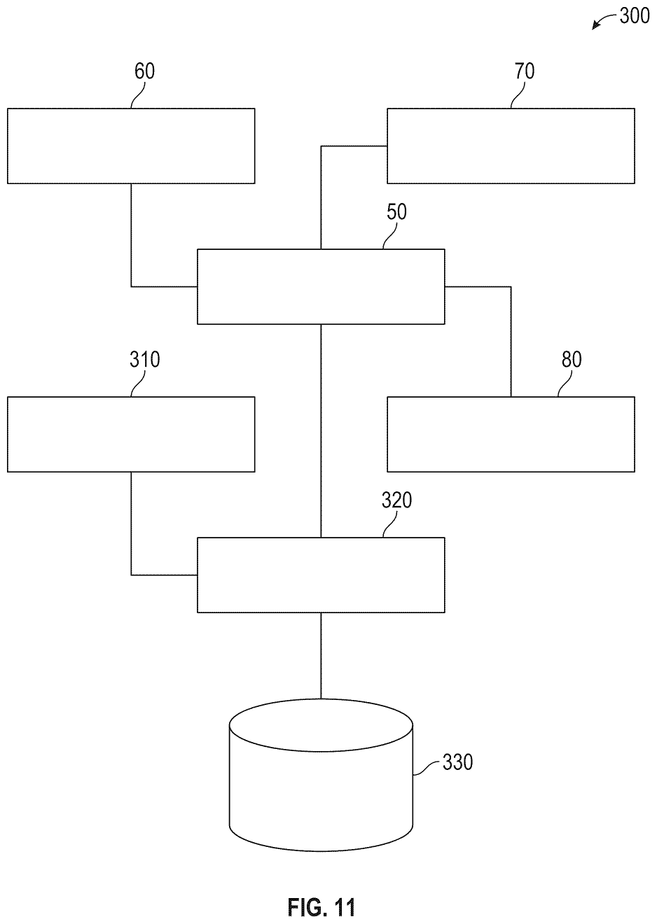

FIG. 11 shows a system 300 for controlling a reconfigurable display assembly 100, 100′, 100″, 100′″ according to one or more embodiments. The system includes an on-board controller 50. The on-board controller 50 may be disposed within the vehicle 10 (see FIG. 1). The on-board controller 50 may be a single controller or multiple controllers. The on-board controller 50 may be operably coupled to one or more on-board input systems 60. The on-board input systems 60 may include, as non-limiting examples, an accelerator, brakes, steering systems, systems for user preferences, systems for physical controls, systems for voice recognition, systems for gesture controls, vehicle infotainment applications, vehicle features applications, vehicle human machine interface displays, external and/or internal cameras, sensors, lidar systems, radar systems, ultrasound systems, automated driving systems, facial recognition systems, and/or other on-board input systems known in the art.

The on-board controller 50 may be operably coupled to one or more system output systems 70. The one or more system output systems 70 may include the reconfigurable display assembly 100, 100′, 100″, 100′″. The on-board controller 60 may be operably coupled to a non-transitory computer-readable medium 80. The non-transitory computer-readable medium 80 may include one or more algorithms. The one or more algorithms may determine a desired vehicle display configuration based on one or more inputs from the on-board input systems 60. As a non-limiting example, the one or more algorithms may determine a desired vehicle display configuration based on user defined preference, user history, user command, selected vehicle application, driving context, etc.

The on-board controller 50 may be operably coupled (for example, via wireless communications) to a data and communication network 320. The data and communication network 320 may be operably coupled to off-board input systems 310 and/or data servers 330. As non-limiting examples, the off-board input systems 310 may include traffic systems, road database systems, vehicle-to-everything systems, the internet, global positioning systems, wifi systems, satellites, etc.

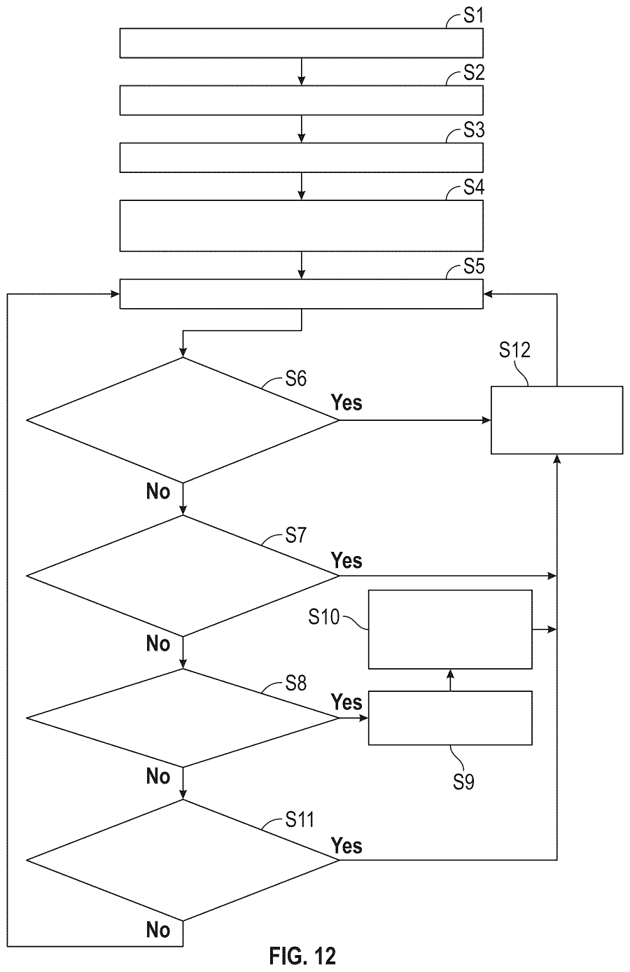

FIG. 12 shows a process of controlling a reconfigurable display assembly 100, 100′, 100″, 100′″ according to one or more embodiments. In a first step S1, the on-board controller 50 may receive input from a user for display preferences. For example, the user may set up display preferences via a mobile application or an in-vehicle system. In step S2, the on-board controller 50 may detect a presence of the user within the vehicle 10. In step S3, the on-board controller 50 may identify the user. The on-board controller 50 may identify the user by, for example, camera, sensor, key fob, personal device, etc. In step S4, the on-board controller 50 may configure the reconfigurable display assembly 100, 100′, 100″, 100′″ based on display preferences for the user identified in step S3.

In step S5, on-board controller 50 starts a reconfiguration determination. In step S6, a determination is made whether a new vehicle application has been selected that would trigger reconfiguration. If yes in step S6, the process moves to step S12 in which the reconfigurable display assembly 100, 100′, 100″ 100′″ is adjusted based on the selected new vehicle application. If no in step S6, the process moves to step S7. In step S7, a determination is made whether a change in driving context has occurred that would trigger reconfiguration. If yes in step S7, the process moves to step S12 in which the reconfigurable display assembly 100, 100′, 100″, 100′″ is adjusted based on the changed driving context. If no in step S7, the process moves to step S8. In step S8, a determination is made whether the user has selected a reconfiguration option. If yes in step S8, the process moves to step S9 in which a user command is received, then to step S10 in which the user command is added to a machine learning algorithm, and then to step S12 in which the reconfigurable display assembly 100, 100′, 100″, 100′″ is adjusted based on the user command. If no in step S8, the process moves to step S11. In step S11, a determination is made whether the machine learning algorithm has triggered reconfiguration. If yes in step S11, the process moves to step S12 in which the reconfigurable display assembly 100, 100′, 100″, 100′″ is adjusted based on the machine learning algorithm. If no in step S11, the process returns to step S5.

A process according to one or more embodiments may omit one or more of the steps in FIG. 12 and may perform the steps in a different order than shown in FIG. 12.

A reconfigurable display assembly 100, 100′, 100″, 100′″ according to one or more embodiments, a system 300 for controlling a reconfigurable display assembly 100, 100′, 100″, 100′″ according to one or more embodiments, and/or a process of controlling a reconfigurable display assembly 100, 100′, 100″, 100′″ according to one or more embodiments may allow multiple displays of the reconfigurable display assembly 100, 100′, 100″, 100′″ to be reconfigured and/or combined as appropriate for current context, and/or by user define preference, user history user, command, selected vehicle application, driving context, etc. A reconfigurable display assembly 100, 100′, 100″, 100′″ according to one or more embodiments, a system 300 for controlling a reconfigurable display assembly 100, 100′, 100″, 100′″ according to one or more embodiments, and/or a process of controlling a reconfigurable display assembly 100, 100′, 100″, 100′″ according to one or more embodiments may allow for improved user-performance based on display orientation, location, and/or combination.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. An assembly for a vehicle comprising:
a driver seat;
a dashboard; and
a reconfigurable display assembly comprising a first display and a second display that are movably mounted on the dashboard,
wherein the reconfigurable display assembly is adjustable between a first configuration in which the first display and the second display are spaced apart and a second configuration in which the first display is directly adjacent to the second display,
wherein, the first display comprises a side display surface and a main display surface that are configured to display images and/or video,
wherein, in the first configuration, lateral ends of the side display surface are flush with the dashboard and faces toward the driver seat while the main display surface faces away from the driver seat, and
wherein, in the second configuration, the side display surface faces away from the driver seat and the main display surface faces toward the driver seat.

2. The assembly of claim 1, wherein the first display and the second display are in direct contact in the second configuration.

3. The assembly of claim 1, wherein the reconfigurable display assembly further comprises a third display movably mounted on the dashboard, the third display being spaced from the first display and the second display in the first configuration and directly adjacent to the first display and the second display in the second configuration.

4. The assembly of claim 1, further comprising a display adjustment assembly configured to rotate the first display from the first configuration to the second configuration.

5. The assembly of claim 1, further comprising a display adjustment assembly configured to translate the second display from the first configuration to the second configuration.

6. The assembly of claim 1, wherein the second display comprises a main display surface configured to display images and/or video.

7. The assembly of claim 6, wherein the main display surface of the first display and the main display surface of the second display are positioned to be continuous with each other in the second configuration.

8. The assembly of claim 6, wherein the main display surface of the first display and the main display surface of the second display are parallel to each other in the second configuration.

9. A vehicle comprising:
a driver seat;
a dashboard; and
a reconfigurable display assembly comprising a first display and a second display that are movably mounted on the dashboard,
wherein the reconfigurable display assembly is adjustable between a first configuration in which the first display and the second display are spaced apart and a second configuration in which the first display is directly adjacent to the second display,
wherein, the first display comprises a side display surface and a main display surface that are configured to display images and/or video,
wherein, in the first configuration, lateral ends of the side display surface are flush with the dashboard and faces toward the driver seat while the main display surface faces away from the driver seat, and
wherein, in the second configuration, the side display surface faces away from the driver seat and the main display surface faces toward the driver seat.

10. The vehicle of claim 9, wherein the first display and the second display are in direct contact in the second configuration.

11. The vehicle of claim 9, wherein the first display is an instrument panel display and the second display is an infotainment system display.

12. The vehicle of claim 9, wherein the reconfigurable display assembly further comprises a third display movably mounted on the dashboard, the third display being spaced from the first display and the second display in the first configuration and directly adjacent to the first display and the second display in the second configuration.

13. The vehicle of claim 9, further comprising a display adjustment assembly configured to rotate the first display from the first configuration to the second configuration.

14. The vehicle of claim 9, further comprising a display adjustment assembly configured to translate the second display from the first configuration to the second configuration.

15. The vehicle of claim 9, wherein the second display comprises a main display surface configured to display images and/or video.

16. The vehicle of claim 15, wherein the main display surface of the first display and the main display surface of the second display are positioned to be continuous with each other in the second configuration.

17. The vehicle of claim 15, wherein in the first configuration, the side display surface faces a rearward direction of the vehicle, and in the second configuration, the main display surface faces the rearward direction of the vehicle.

18. The vehicle of claim 9, further comprising a controller configured to adjust the reconfigurable display assembly based on receiving a selection of a new vehicle application, determination of a change in driving context, or receiving selection of a reconfiguration option.

19. The vehicle of claim 15, wherein the main display surface of the first display and the main display surface of the second display are parallel to each other in the second configuration.

20. A vehicle comprising:
a driver seat;
a dashboard;
a reconfigurable display assembly comprising a first display and a second display that are movably mounted on the dashboard;
a display adjustment assembly;
one or more display adjustment assemblies; and
a controller,
wherein the reconfigurable display assembly is adjustable between a first configuration in which the first display and the second display are spaced apart and a second configuration in which the first display directly contacts the second display,
wherein the one or more display adjustment assemblies is configured to rotate the first display from the first configuration to the second configuration and to translate the second display from the first configuration to the second configuration,
wherein the first display comprises a side display surface and a main display surface that are configured to display images and/or video, and the second display comprises a main display surface configured to display images and/or video,
wherein the main display surface of the first display and the main display surface of the second display are positioned to be continuous with each other in the second configuration,
wherein in the first configuration, the side display surface faces a rearward direction of the vehicle, and in the second configuration, the main display surface faces the rearward direction of the vehicle, and
wherein the main display surface of the first display and the main display surface of the second display are parallel to each other in the second configuration,
wherein, in the first configuration, lateral ends of the side display surface are flush with the dashboard and faces toward the driver seat while the main display surface faces away from the driver seat, and
wherein, in the second configuration, the side display surface faces away from the driver seat and the main display surface faces toward the driver seat.
